(19) United States
(12) Patent Application Publication
(10) Pub. No.: US 2021/0189950 A1
(43) Pub. Date: Jun. 24, 2021

(54) SUPERCHARGING DEVICE

(71) Applicant: KABUSHIKI KAISHA TOYOTA JIDOSHOKKI, Kariya-shi, Aichi-ken (JP)

(72) Inventor: Kenta AKIMOTO, Kariya-shi (JP)

(73) Assignee: KABUSHIKI KAISHA TOYOTA JIDOSHOKKI, Kariya-shi, Aichi-ken (JP)

(21) Appl. No.: 16/076,032

(22) PCT Filed: Feb. 9, 2017
(86) PCT No.: PCT/JP2017/004773

§ 371 Date: Aug. 7, 2018

(30) Foreign Application Priority Data
Feb. 22, 2016 (JP) 2016-030775

(51) Int. Cl. F02B 39/12; F02B 39/04; F02B 33/40; F02B 39/10

(52) U.S. Cl. CPC F02B 39/12; F02B 39/04; F04D 25/0606; F02B 39/10; F02B 33/40

(57) ABSTRACT

This supercharging device is provided with an impeller having a shaft, a motor generator configured so as to rotate the impeller to perform supercharging, a planetary gear mechanism, and a restricting mechanism configured so as to restrict the rotation of the impeller. The planetary gear mechanism has a sun gear to which the shaft is linked, a ring gear configured so as to rotate by means of motive power from an engine, a plurality of planetary gears, and a carrier linked to the plurality of planetary gears. The carrier has a cylinder part through which the shaft passes. The motor generator has a rotor integrated with the outer peripheral surface of the cylinder part, and a stator disposed on the radially outward side of the rotor.

### TECHNICAL FIELD

The present invention relates to a supercharging device that improves a motor-driven supercharger to increase versatility.

### BACKGROUND ART

A turbocharger is a well-known supercharging device that increases engine power by using exhaust energy from the engine to rotate a compressor impeller and performs supercharging. In the turbocharger, a time lag (turbo lag) may occur before supercharging begins during acceleration. To compensate for the time lag until supercharging begins during acceleration, a motor-driven supercharger that includes an electrically powered impeller may be used together with the turbocharger.

Generally, the motor-driven supercharger is used effectively only under situations that are easily affected by the turbo lag described above such as during rapid acceleration. Thus, it is desirable that the motor-driven supercharger be used effectively in more various situations. Accordingly, patent document 1 discloses an example of a supercharging device that improves the motor-driven supercharger and makes the motor-driven supercharger versatile. The supercharging device includes a planetary gear mechanism that incorporates a sun gear, a ring gear, and a planetary gear. An impeller is coupled to one of the sun gear, the ring gear, and the planetary gear, and power from the engine is input to one of the two remaining gears. The last gear is rotated by a motor-generator (electric device).

When the motor-generator is actuated as a motor in a state in which a brake acts to restrict rotation of the impeller, the power output from the motor is transferred to the engine, not the impeller. In this way, the supercharging device assists the engine to realize mild hybrid.

Alternatively, the motor-generator can be actuated as a generator to generate electric power from engine power. This allows for effective use of the supercharging device by actuating the supercharging device for mild hybrid or as an electric generator even when the motor does not rotate the impeller, that is, when the supercharging device is not used as a motor-driven compressor.

### PRIOR ART LITERATURE

### Patent Literature

Patent Document 1: Japanese National Phase Laid-Open Patent Publication No. 2009-520915.

### SUMMARY OF THE INVENTION

### Problem to be Solved by the Invention

However, the supercharging device described in patent document 1 has a tendency to be enlarged. As shown in FIG. 1 of patent document 1, when the motor-generator is arranged outward from the planetary gear mechanism in an axial direction, that is, when the motor-generator and the planetary gear mechanism are arranged next to each other in the axial direction, the dimension of the supercharging device increases in the axial direction. Further, as shown in FIG. 2 of patent document 1, when the motor-generator is arranged outward from the ring gear in a radial direction, the dimension of the supercharging device increases in the radial direction. This adversely affects the mountability of the supercharging device on a vehicle.

One object of the present invention is to limit enlargement of a supercharging device that improves the motor-driven supercharger and makes the motor-driven supercharger versatile.

### Means for Solving the Problem

A supercharging device that solves the above problem includes an impeller, a motor-generator, a planetary gear mechanism, and a restriction mechanism. The impeller includes a shaft. The motor-generator is configured to perform supercharging by rotating the impeller when functioning as a motor. The planetary gear mechanism includes a sun gear, a ring gear, a plurality of planetary gears, and a carrier. The shaft is coupled to the sun gear. The ring gear is configured to be rotated by power from the engine. The planetary gears are arranged between the sun gear and the ring gear. The carrier is coupled to the planetary gears. The restriction mechanism is configured to restrict rotation of the impeller. The carrier includes a cylindrical portion, through which the shaft extends. The motor-generator includes a rotor and a stator. The rotor is integrated with the outer circumferential surface of the cylindrical portion. The stator is arranged outward from the rotor in a radial direction.

### BRIEF DESCRIPTION OF THE DRAWINGS

FIG. 1 is a cross-sectional side view of a supercharging device in accordance with the first embodiment.

FIG. 2A is a schematic diagram showing the action of a planetary gear mechanism when the supercharging device of FIG. 1 is actuated as a motor-driven compressor, FIG. 2B is a schematic diagram showing the action of a planetary gear mechanism when the supercharging device of FIG. 1 is actuated for mild hybrid, and FIG. 2C is a schematic diagram showing the action of a planetary gear mechanism when the supercharging device of FIG. 1 is actuated as a generator.

FIG. 3 is a cross-sectional side view of a supercharging device in accordance with the second embodiment.

FIG. 4A is a schematic diagram showing the action of a planetary gear mechanism when the supercharging device of FIG. 3 is actuated as a motor-driven compressor, FIG. 4B is a schematic diagram showing the action of a planetary gear mechanism when the supercharging device in FIG. 3 is actuated for mild hybrid, and FIG. 4C is a schematic diagram showing the action of a planetary gear mechanism when the supercharging device of FIG. 3 is actuated as a generator.

### EMBODIMENTS OF THE INVENTION

### First Embodiment

A supercharging device in accordance with a first embodiment will now be described with reference to the drawings. In the description hereafter, the supercharging device is used together with a turbocharger. However, the turbocharger may be omitted.

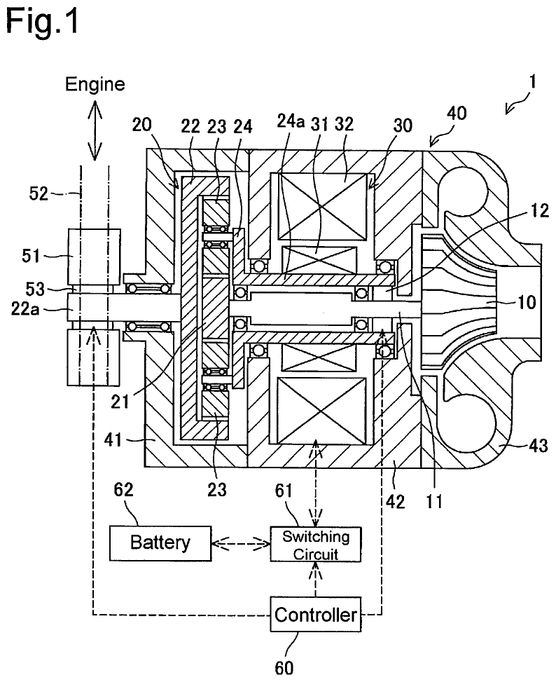

As shown in FIG. 1, the supercharging device 1 includes a housing 40 that accommodates an impeller 10, a planetary gear mechanism 20, and a motor-generator 30. The impeller 10 is rotated to pressurize intake gas, which is supplied to the engine, and perform supercharging. The housing 40 includes a first housing portion 41 that mainly accommodates the planetary gear mechanism 20, a second housing portion 42 that mainly accommodates the motor-generator 30, and a third housing portion 43 that mainly accommodates the impeller 10.

The planetary gear mechanism 20 includes a sun gear 21 that is an external gear, a ring gear 22 that is an internal gear having a larger diameter than the sun gear 21, a plurality of planetary gears 23 that are external gears, and a carrier 24 that is coupled to the planetary gears 23. The ring gear 22 is arranged around the sun gear 21, and the planetary gears 23 are arranged between the sun gear 21 and the ring gear 22. The carrier 24 rotates at a rotation speed that is the same as the rotation speed of planetary gears 23 rotating (orbiting) around the sun gear 21.

The sun gear 21 is coupled to one end (left end as viewed in FIG. 1) of a shaft 11. Further, the impeller 10 is coupled to the other end (right end as viewed in FIG. 1) of the shaft 11. Thus, the impeller 10, the shaft 11, and the sun gear 21 rotate integrally with one another.

A rotation shaft 22a of the ring gear 22 is partially projected from the first housing portion 41, and a pulley 51 is coupled to the projected portion. A belt 52 runs around the pulley 51 to transfer power from the engine (rotation of crankshaft) so that the power from the engine is input via the belt 52 and the pulley 51 to the rotation shaft 22a. As described below, when the supercharging device 1 is actuated for mild hybrid, the motor-generator 30 functions as a motor and the output of the motor-generator 30 is transferred via the rotation shaft 22a, the pulley 51, and the belt 52 to the engine. A first clutch 53 is arranged between the pulley 51 and the rotation shaft 22a. The first clutch 53 is selectively switchable between a connected state that connects the pulley 51 and the rotation shaft 22a and a disconnected state that disconnects the pulley 51 and the rotation shaft 22a.

The carrier 24, which is coupled to the planetary gears 23, includes a cylindrical portion 24a, and the shaft 11 extends through the cylindrical portion 24a. The shaft 11 is coaxial with the cylindrical portion 24a. A second clutch 12 is arranged between the shaft 11 and the cylindrical portion 24a. The second clutch 12 is selectively switchable between a connected state that connects the shaft 11 and the cylindrical portion 24a (carrier 24) and a disconnected state that disconnects the shaft 11 and the cylindrical portion 24a (carrier 24). When the second clutch 12 is switched to the connected state, the shaft 11 and the carrier 24 are rotatable integrally with each other. When the second clutch 12 is switched to the disconnected state, the shaft 11 and the carrier 24 are rotatable relative to each other.

Further, the first clutch 53 and the second clutch 12 are, for example, configured by electromagnetic clutches. The first clutch 53 and the second clutch 12 are switchable between the connected state and the disconnected state by a command from a controller 60.

The motor-generator 30 includes a rotor 31 and a stator 32. The rotor 31 is integrated with the outer circumferential surface of the cylindrical portion 24a of the carrier 24, and the stator 32 is arranged outward from the rotor 31 in the radial direction. Accordingly, the impeller 10, the shaft 11, the planetary gear mechanism 20, and the motor-generator 30 are coaxial. The rotor 31 includes, for example, magnets. The stator 32 includes, for example, coils that are energized and controlled by the controller 60. Nonetheless, the rotor 31 and the stator 32 are not specifically limited to the above configurations. Further, the phrase “the rotor 31 is integrated with the outer circumferential surface of the cylindrical portion 24a” means that the rotor 31 is mounted on or fixed to the outer circumferential surface of the cylindrical portion 24a so that the rotor 31 and the cylindrical portion 24a rotate integrally with each other.

A switching circuit 61 electrically connects the stator 32, which includes the coils, to the controller 60 and a battery 62. The switching circuit 61 includes a motor circuit that has the motor-generator 30 function as a motor and a generator circuit that has the motor-generator 30 function as a generator. The motor circuit and the generator circuit are switchable in accordance with a command from the controller 60.

When actuating the motor-generator 30 as a motor, the controller 60 switches the switching circuit 61 to the motor circuit to supply power from the battery 62 via the switching circuit 61 to the stator 32, and rotates the rotor 31 integrally with the carrier 24. When actuating the motor-generator 30 as a generator, the controller 60 switches the switching circuit 61 to the generator circuit so that the rotor 31 receives power from the engine and rotates integrally with the carrier 24. Thus, the battery 62 is charged by the stator 32 via the switching circuit 61.

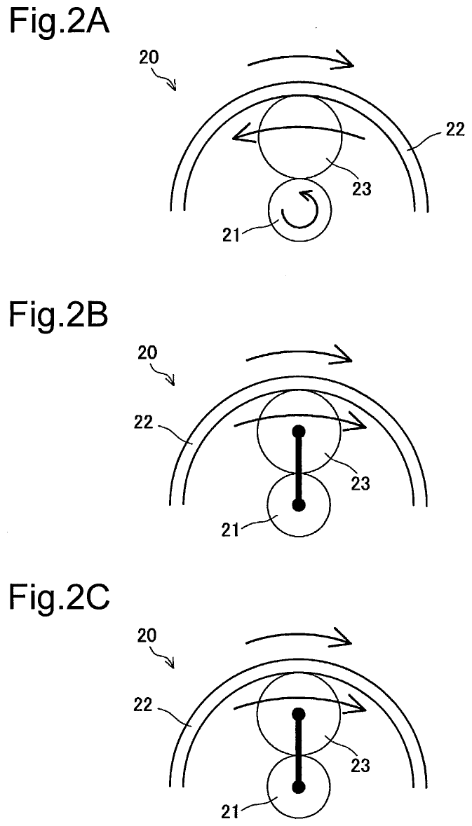

The operation of the supercharging device 1 will now be described with reference to FIG. 2. The controller 60 determines whether to actuate the supercharging device 1 as a motor-driven compressor, a mild hybrid, or a generator based on, for example, the operation amount of the accelerator or the rotation speed of the engine.

For example, when the operation amount of the accelerator is rapidly increased while the rotation speed of the engine is in a low range, a turbo lag has a tendency to occur in the turbocharger. Thus, to assist supercharging when a turbo lag occurs, the supercharging device 1 is actuated as a motor-driven compressor. Specifically, the controller 60 connects the first clutch 53, disconnects the second clutch 12, and switches the switching circuit 61 to the motor circuit. In this case, as shown in FIG. 2A, the rotor 31 rotates so that the planetary gears 23 rotate (orbit) in a direction opposite to the rotation direction of the ring gear 22. This rotates the sun gear 21 at a rotation speed obtained by multiplying a relative rotation speed difference of the ring gear 22 and the planetary gears 23 by a speed-up ratio. As a result, the rotation speed of the impeller 10 is increased. However, the first clutch 53 may be disconnected since engine power does not necessarily have to be used for supercharging.

Instead of using the power from the motor (motor-generator 30) for supercharging, the use of the power to directly assist the rotation of the engine may, in some cases, be preferable. In such a case, the controller 60 connects both the first clutch 53 and the second clutch 12 and switches the switching circuit 61 to the motor circuit so that the supercharging device 1 is actuated for mild hybrid. In this case, as shown in FIG. 2B, the rotor 31 rotates so that the planetary gears 23 rotate (orbit) in the same direction as the rotation direction of the ring gear 22. Thus, the ring gear 22 is rotated by the planetary gears 23 and some of the power from the motor (motor-generator 30) is transferred via the pulley 51 and the belt 52 to the engine. This assists the rotation of the engine.

Finally, for example, during deceleration or the like, the supercharging device 1 is actuated as a generator to charge the battery 62 with engine power. In this case, the controller 60 connects both the first clutch 53 and the second clutch 12 and switches the switching circuit 61 to the generator circuit. Consequently, as shown in FIG. 2C, as the power from the engine rotates the ring gear 22, the planetary gears 23 rotate (orbit). This integrally rotates the rotor 31 with the carrier 24 and generates power with the stator 32. The power charges the battery 62 via the switching circuit 61. In this state, the sun gear 21 rotates integrally with the planetary gears 23. Thus, the impeller 10 is rotated and supercharging is slightly performed. The second clutch 12 may be disconnected during power generation. In this case, the rotation of the impeller 10 will not be restricted by the second clutch 12 and a large amount of engine power will be used to rotate the impeller 10. Thus, this may decrease the power generation efficiency.

### Second Embodiment

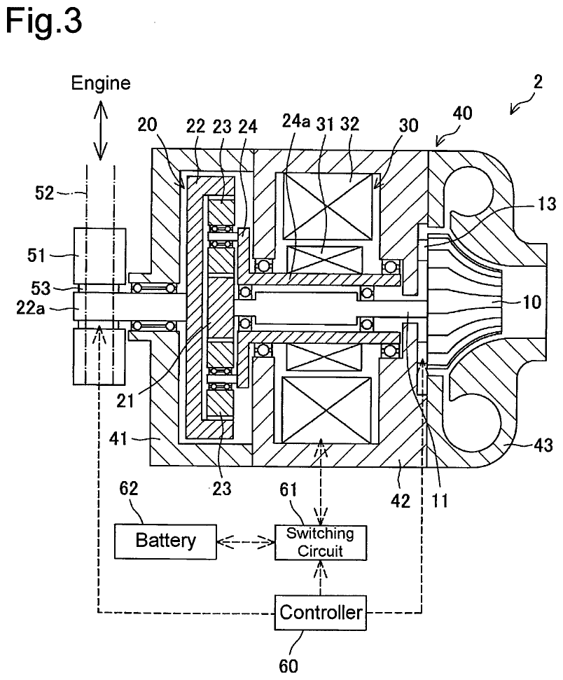

A supercharging device in accordance with a second embodiment will now be described with reference to FIG. 3. In the first embodiment, the second clutch 12 is arranged between the cylindrical portion 24a of the carrier 24 and the shaft 11 and functions as a restriction mechanism that restricts rotation of the impeller 10. The second embodiment differs from the first embodiment in that, instead of the second clutch 12, a third clutch 13 is arranged between the impeller 10 and the housing 40. Otherwise, the structure is the same as the first embodiment. Thus, same reference numerals are given to those components that are the same as the corresponding components of the first embodiment. Such components will not be described.

In the supercharging device 2 in accordance with the second embodiment, as described above, the third clutch 13 is arranged between the impeller 10 and the housing 40. More specifically, the third clutch 13 is arranged between a back surface of the impeller 10 and a side surface of the second housing portion 42 that opposes the back surface of the impeller 10. The third clutch 13 is, for example, configured by an electromagnetic clutch. Further, the third clutch 13 is selectively switchable between a connected state that connects the impeller 10 and the second housing portion 42 and a disconnected state that disconnects the impeller 10 and the second housing portion 42. When a command from the controller 60 connects the third clutch 13, the impeller 10 is connected to the stationary second housing portion 42. This stops the rotation of the impeller 10. When the third clutch 13 is disconnected, the impeller 10 is rotatable.

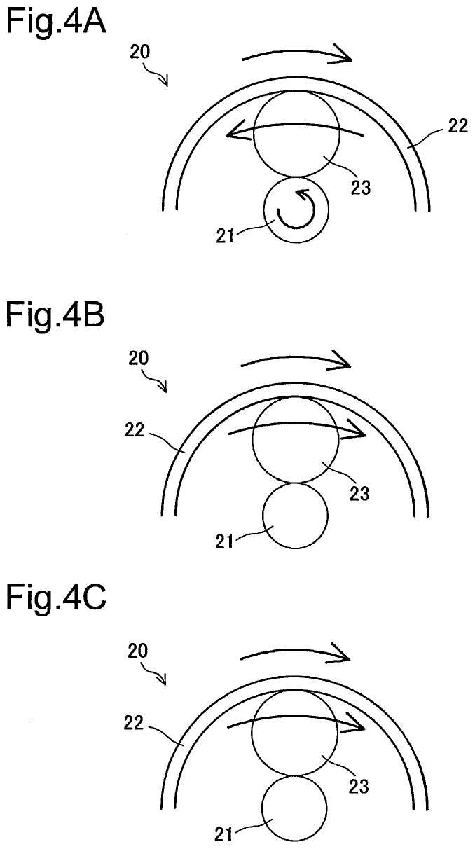

The operation of the supercharging device 2 is basically the same as that of the supercharging device 1 in accordance with the first embodiment. That is, when actuating the supercharging device 2 as a motor-driven compressor, the controller 60 connects the first clutch 53, disconnects the third clutch 13, and switches the switching circuit 61 to the motor circuit. This increases the rotation speed of the impeller 10 (refer to FIG. 4A).

When actuating the supercharging device 2 for mild hybrid, the controller 60 connects both the first clutch 53 and the third clutch 13 and switches the switching circuit 61 to the motor circuit. This transfers the power from the motor (motor-generator 30) via the pulley 51 and the belt 52 to the engine and assists rotation of the engine (refer to FIG. 4B).

When actuating the supercharging device 2 as a generator, the controller 60 connects both the first clutch 53 and the third clutch 13 and switches the switching circuit 61 to the generator circuit. This rotates the rotor 31 with the power from the engine. As a result, the power generated with the stator 32 charges the battery 62 via the switching circuit 61 (refer to FIG. 4C).

When the supercharging device 2 in accordance with the second embodiment is actuated as a mild hybrid or a generator, as shown in FIGS. 4B and 4C, the third clutch 13 is connected to completely stop the rotation of the sun gear 21. That is, the second embodiment differs from the first embodiment in that the rotation of the impeller 10 is completely stopped.

### Advantages

In both the supercharging device 1 in accordance with the first embodiment and the supercharging device 2 in accordance with the second embodiment, the carrier 24 of the planetary gear mechanism 20 includes the cylindrical portion 24a, through which the shaft 11 of the impeller 10 extends. Further, the motor-generator 30 includes the rotor 31, which is integrated with the outer circumferential surface of the cylindrical portion 24a, and the stator 32, which is arranged outward from the rotor 31 in the radial direction. The arrangement of the motor-generator 30 outward in the radial direction from the cylindrical portion 24a, through which the shaft 11 extends, eliminates the need for arranging the motor-generator 30 outward from the planetary gear mechanism 20 in the axial direction. This avoids enlargement of the supercharging devices 1 and 2 in the axial direction. Further, the diameter of the cylindrical portion 24a is decreased and a space is obtained in the radial direction between the cylindrical portion 24a and the outer circumference of the ring gear 22. The space is sufficient for accommodating the motor-generator 30 and enlargement of the supercharging devices 1 and 2 can be avoided in the radial direction. Hence, enlargement of the supercharging devices 1 and 2 is limited in both the axial and radial directions.

In the supercharging device 1 in accordance with the first embodiment, the restriction mechanism that restricts rotation of the impeller 10 is configured as the second clutch 12, which is selectively switchable between the connected state that connects the cylindrical portion 24a and the shaft 11 and the disconnected state that disconnects the cylindrical portion 24a and the shaft 11. When the second clutch 12 is connected, the carrier 24 and the shaft 11 become integrally rotatable and rotate the impeller 10.

When actuating the supercharging device 1 as a generator, in a state in which the sun gear 21 is completely stopped (refer to FIG. 4C) in the supercharging device 2 in accordance with the second embodiment, the planetary gears 23 are reduced in speed when rotating (orbiting) as the power from the engine rotates the ring gear 22. As a result, the rotation speed of the rotor 31 is decreased. In the supercharging device 1 in accordance with the first embodiment, as shown in FIG. 2C, the planetary gears 23 integrally rotate with the sun gear 21 as the power from the engine rotates the ring gear 22. In this case, the planetary gears 23 are not reduced in speed, and the rotor 31 rotates at a higher rotation speed than that in the second embodiment. That is, in the supercharging device 1 in accordance with the first embodiment, the power generation efficiency is improved when the supercharging device 1 is actuated as a generator.

In the supercharging device 2 in accordance with the second embodiment, the restriction mechanism that restricts rotation of the impeller 10 is configured as the third clutch 13, which is selectively switchable between the connected state that connects the impeller 10 and the housing 40 and the disconnected state that disconnects the impeller 10 and the housing 40. In the supercharging device 2 in accordance with the second embodiment, when the third clutch 13 is connected, rotation of the impeller 10 is completely stopped.

When actuating the supercharging device 2 for mild hybrid, compared to when the planetary gears 23 are rotated integrally with the sun gear 21 in the supercharging device 1 in accordance with the first embodiment (refer to FIG. 2B), as shown in FIG. 4B, the rotation speed (orbit speed) of the planetary gears 23 can be higher when the sun gear 21 is stopped. This allows the power from the motor (motor-generator 30) to assist the engine even when the engine is running at higher rotation speeds.

### OTHER EMBODIMENTS

The present invention is not limited to the above embodiments, and the elements in the embodiments may be combined or changed within the scope of the claims.

For example, in the second embodiment, the third clutch 13 is arranged between the impeller 10 and the housing 40 and connection of the third clutch 13 stops rotation of the impeller 10. Nonetheless, the location of the clutch may be changed as long as rotation of the impeller 10 can be stopped.

Further, a supercharging device may include both the second clutch 12 and the third clutch 13. As described above, the arrangement of the second clutch 12 improves the power generation efficiency of the supercharging when actuated as a generator. Further, the arrangement of the third clutch 13 allows for assistance of the engine even in a high speed rotation range. Thus, the arrangement of both the second clutch 12 and the third clutch 13 in a supercharging device allows for suitable switching and improves the supercharging device that functions as a generator and functions to realize mild hybrid.

1. A supercharging device comprising:
an impeller that includes a shaft;
a motor-generator configured to perform supercharging by rotating the impeller when functioning as a motor;
a planetary gear mechanism that includes
a sun gear that the shaft is coupled to,
a ring gear configured to be rotated by power from an engine,
a plurality of planetary gears arranged between the sun gear and the ring gear, and
a carrier coupled to the plurality of the planetary gears; and
a restriction mechanism configured to restrict rotation of the impeller, wherein
the carrier includes a cylindrical portion through which the shaft extends, and
the motor-generator includes a rotor that is integrated with an outer circumferential surface of the cylindrical portion and a stator that is arranged outward from the rotor in a radial direction.

2. The supercharging device according to claim 1, wherein the restriction mechanism is a clutch configured to be selectively switched between a connected state that connects the cylindrical portion and the shaft and a disconnected state that disconnects the cylindrical portion and the shaft.

3. The supercharging device according to claim 1, further comprising a housing that accommodates the impeller, the motor-generator, and the planetary gear mechanism, wherein
the restriction mechanism is a clutch configured to be selectively switched between a connected state that connects the impeller and the housing and a disconnected state that disconnects the impeller and the housing.

4. The supercharging device according to claim 2, further comprising a housing that accommodates the impeller, the motor-generator, and the planetary gear mechanism, wherein
the restriction mechanism further includes a clutch configured to be selectively switched between a connected state that connects the impeller and the housing and a disconnected state that disconnects the impeller and the housing.
